(19) United States
(12) Patent Application Publication
(10) Pub. No.: US 2024/0376938 A1
(43) Pub. Date: Nov. 14, 2024

(54) FLEXIBLE DRIVETRAIN FOR MOBILE GENERATOR

(71) Applicant: VOLTAGRID LLC, Bellaire, TX (US)

(72) Inventor: LESLIE MICHAEL WISE, Bellaire, TX (US)

(73) Assignee: VOLTAGRID LLC, Bellaire, TX (US)

(21) Appl. No.: 18/654,874

(22) Filed: May 3, 2024

Related U.S. Application Data
(60) Provisional application No. 63/501,917, filed on May 12, 2023.

(51) Int. Cl. F16D 3/32; F02B 63/04

(52) U.S. Cl. CPC F16D 3/32; F02B 63/047; F02B 63/048

(57) ABSTRACT

A mobile generator includes an engine and an alternator separately mounted on a substantially planar mounting surface, with a flexible drivetrain configured to transmit torque from the engine to the alternator. The flexible drivetrain, which may comprise a universal joint, allows the mobile generator to be transported without the need for re-alignment between the engine and alternator after the generator has reached its destination.

The present application claims priority to U.S. Application 63/501,917 filed on May 12, 2023, which is incorporated herein in its entirety, and relates generally to mobile generators and, more particularly, to a flexible drivetrain for a mobile generator.

### TECHNICAL FIELD

### Background

Although large mobile generators have been known for many years, they have recently become more common, in part due to the increasing use of microgrids. A microgrid is a self-sufficient energy system that serves a discrete geographic footprint. The microgrid is made up of a decentralized group of electricity sources and loads that normally operate connected to, and synchronous with, the traditional wide area synchronous grid (macrogrid). These electricity sources can also disconnect to “island mode,” where the microgrid operates independently of the macrogrid, and function autonomously as physical or economic conditions dictate. In this way, a microgrid can effectively integrate various sources of distributed generation, especially renewable energy sources, and can supply emergency power, changing between island and connected modes. Microgrids are also capable of dispatching power to the macrogrid.

Microgrids are often utilized as localized energy sources, where power transmission and distribution from a major centralized energy source is impractical to implement and/or cost prohibitive.

However, microgrids often have a large geographical footprint with components that are difficult or costly to move. Accordingly, certain microgrids may be impractical for short term operations, such as oil and gas operations. One way that these challenges have been addressed for activities such as oil and gas operations is through the use of large generators mounted on trucks, such that they may be more easily moved from one location to another. The use of such mobile generators, however, has led to additional obstacles for microgrid operators.

One such obstacle involves the interface between a generator engine and its corresponding alternator. As one of ordinary skill in the art is aware, alternators are used to convert mechanical energy from a generator into alternating current (AC) electrical energy. Traditionally, mobile generators have comprised an engine connected to an alternator via a conventional drivetrain. The engine and alternator are generally unitized via mounting on a common foundation. The standard configuration requires very careful alignment with extremely tight tolerances.

Some generators require a gearbox, in addition to an alternator. Most generators in the US output electricity at a frequency of 60 Hz, which generally corresponds to an engine operating at 1800 RPM. Certain engines used in large mobile generators, however, may operate at a different, such as 1500 RPM, which may correspond to a different frequency of electrical output, such as 50 Hz. In a situation like this, a gearbox must be added between the engine and alternator, in order to increase the frequency of the generated electrical output from 50 Hz to 60 Hz. When a gearbox is required, the design tolerances and alignment requirements discussed above become even more complicated because it is more difficult to maintain alignment specifications for three independent components.

While such an arrangement is relatively straightforward for a stationary generator, the same is not true for mobile generators that are moved on a regular basis, often on a flatbed trailer over long distances. A stationary generator can be installed on a rigid, generally permanent foundation, aligned, and generally will remain aligned without further intervention. In contrast, mobile generators often experience vibration and shifting when they are moved from place to place, which tends to disrupt the alignment between the components.

Some smaller mobile generators may have all their components packaged in a single unit to minimize or eliminate the shifting of the components relative to one another. However, this may not be possible for larger generators, in which at least the engine and alternator may be too large and heavy to be transported while connected by any sort of rigid coupling. This is especially the case when a gearbox is also involved. Moreover, even if an engine and alternator are directly coupled, with a flexible coupling between their respective shafts, such a configuration allows for only small deviations in alignment, on the order of 0.001″.

Certain mounting techniques are often used in an effort to minimize relative movement of the engine and alternator. These mounting techniques include rubber supports intended to minimize shock and vibration. Even with such a mounting arrangement, however, some shifting tends to occur during transportation.

As a result of these logistical challenges, each time a mobile generator is moved, the individual components (the engine, the alternator, and (when present) the gearbox) need to be realigned before they can be used in the field. This realignment process can be complicated and time-consuming, particularly when being performed at a remote location, such as an oil and gas wellsite. In some cases, realignment may take between two and eight hours each time the mobile generator is moved to a new location.

Another complicating factor is that, because of the tight tolerances required between the drivetrain and the generator components in a conventional mobile generator, the drivetrain length, and consequently the distances between the components, is constrained. These constraints often result in a weight imbalance that makes transportation of certain mobile generator embodiments impractical or impossible.

Therefore, what is needed is an apparatus, system or method that addresses one or more of the foregoing issues, among one or more other issues.

### SUMMARY

One or more embodiments of the invention enable a mobile generator.

In one embodiment, a mobile generator may comprise an engine and alternator separately mounted on a vehicle. Rather than a conventional drivetrain, a flexible drivetrain is used to connect the engine and alternator. Such a flexible drivetrain may comprise a universal joint, allowing an additional degree of freedom for the connection.

In another embodiment, a gearbox may be included as part of the mobile generator. The gearbox could optionally be mounted to either the engine or the alternator or mounted on a common foundation and connected via a rigid coupling to either the engine or the alternator but, in any case, a flexible drivetrain is used to connect the gearbox to the other portion of the system.

In another embodiment, the gearbox could be mounted on a common foundation with the engine and alternator and connected via flexible drivetrain to both the engine and the alternator.

In another embodiment, the components of a mobile generator package, including the engine and/or the alternator, may be mounted using a plurality of isolated rubber supports along the length of the components, as opposed to more traditional mounting configurations.

### BRIEF DESCRIPTION OF THE DRAWINGS

The accompanying drawings, which are included to provide further understanding and are incorporated in and constitute a part of this specification, illustrates disclosed embodiments and together with the description serves to explain the principles of the disclosed embodiments.

FIG. 1 is a schematic side view of a mobile generator of an illustrative embodiment with a flexible drivetrain and a gearbox attached via rigid coupling to an alternator.

FIG. 2 is a schematic side view of a mobile generator of an illustrative embodiment with a flexible drivetrain and a gearbox attached via rigid coupling to an engine.

FIG. 3 is a schematic side view of a mobile generator of an illustrative embodiment with a flexible drivetrain and a gearbox integral with an alternator.

FIG. 4 is a schematic side view of a mobile generator of an illustrative embodiment with a flexible drivetrain and a gearbox integral with an engine.

FIG. 5 is a schematic view of an illustrative basic universal joint.

FIG. 6 is a schematic view of an illustrative constant-velocity joint.

FIG. 7 is a schematic view of an illustrative double Cardan joint.

While the invention is susceptible to various modifications and alternative forms, specific embodiments thereof are shown by way of example in the drawings and may herein be described in detail. The drawings may not be to scale. It should be understood, however, that the embodiments described herein and shown in the drawings are not intended to limit the invention to the particular form disclosed, but on the contrary, the intention is to cover all modifications, equivalents and alternatives falling within the scope of the present invention as defined by the appended claims.

### DETAILED DESCRIPTION

The present disclosure relates generally to mobile generators and, more particularly, to a generator comprising a separately mounted engine and alternator with a flexible drivetrain connecting the two components.

As noted above, most large generators have traditionally comprised an engine and alternator that are mounted on a common foundation and connected via a conventional drivetrain, such that precise alignment is required between the two components. This configuration has led to challenges for operators of mobile generators, requiring realignment every time the generator is moved to a new location. Such realignment is often expensive, difficult, and time-consuming. The present invention seeks to solve these challenges with mobile generators by providing a flexible drivetrain for transmitting torque from the engine to the alternator.

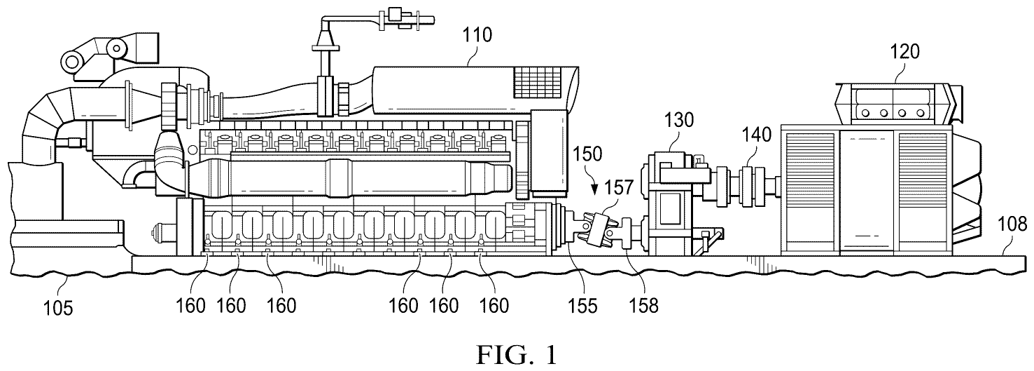

FIG. 1 is a side view of an exemplary embodiment of the present invention. The mobile generator comprises a vehicle 105 with a substantially planar mounting surface 108. Mounted on substantially planar mounting surface 108 are engine 110, alternator 120, and gearbox 130.

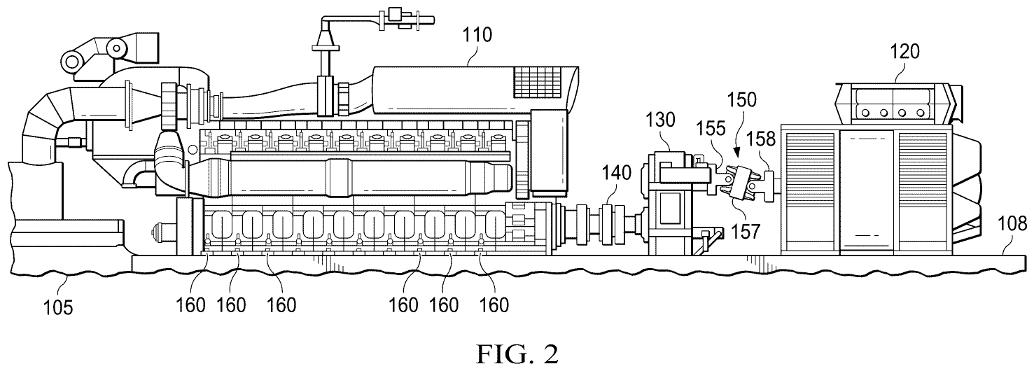

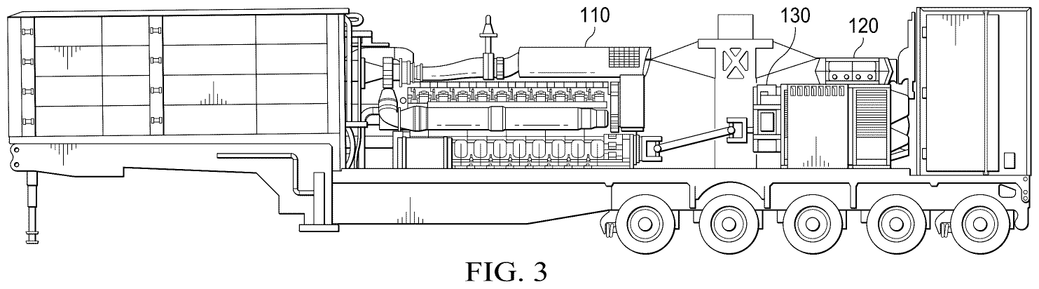

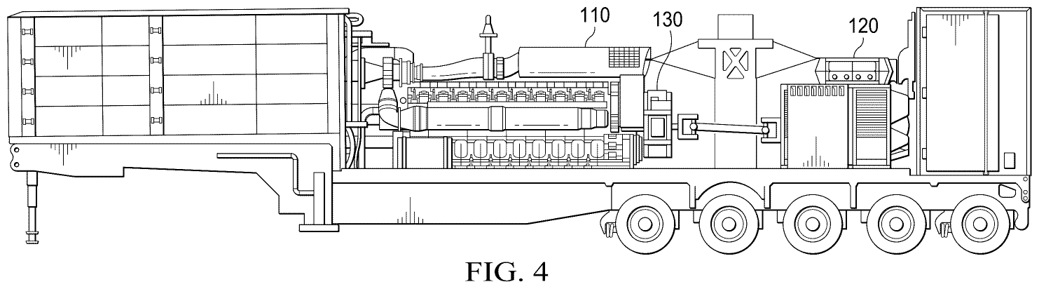

One of ordinary skill in the art will appreciate that gearbox 130 is an optional component shown for illustrative purposes. In a system in which the engine and alternator operate at the same frequency, gearbox 130 would not be required. When gearbox 130 is included in the mobile generator, it may be mounted to substantially planar mounting surface 108 and attached via rigid coupling to the alternator 120, as shown by rigid connection 140 in FIG. 1. Alternatively, gearbox 130 could be mounted to substantially planar mounting surface 108 and attached via rigid coupling to the engine 110, as shown in FIG. 2. In another embodiment, gearbox 130 may be mounted to the alternator 120 instead of to the substantially planar mounting surface 108, as shown in FIG. 3, such that the alternator 120 and gearbox 130 are substantially integral. In another embodiment, gearbox 130 may be mounted to the engine 110 instead of to the substantially planar mounting surface 108, as shown in FIG. 4, such that the engine 110 and gearbox 130 are substantially integral. Regardless of the particular configuration, one of ordinary skill in the art will understand that the system of the present invention may benefit from the inclusion of a torsional damping device to ensure that harmonics are decoupled across the engine, drivetrain, and alternator.

Torque is transmitted from engine 110 through a flexible drivetrain. In this particular embodiment, the flexible drivetrain comprises a double Cardan joint 150, as shown in FIG. 7. Double Cardan joint 150 comprises a first universal joint 155, second universal joint 158, which are connected by yoke 157. The combination of these components transmits torque generated by engine 110 to gearbox 130 or, when gearbox 130 is not present, directly to alternator 120. As one of ordinary skill in the art will appreciate, the flexible connection between first universal joint 155, yoke 157, and second universal joint 158 allows some freedom of movement in the alignment of the axes of the two yokes. For example, it is common for a joint such as double Cardan joint to allow a variation of up to 3° in the alignment between the axes of the first universal joint and second universal joint. Regardless of the precise degree of variation permitted by a particular configuration, the flexible drivetrain of the present invention allows for materially greater misalignment between the engine, alternator and/or gearbox, in relation to existing flexible couplings. This freedom of movement is beneficial because it allows the engine and alternator to be separately mounted and transported while remaining connected, without the need to precisely realign the connection after the generator has reached its destination.

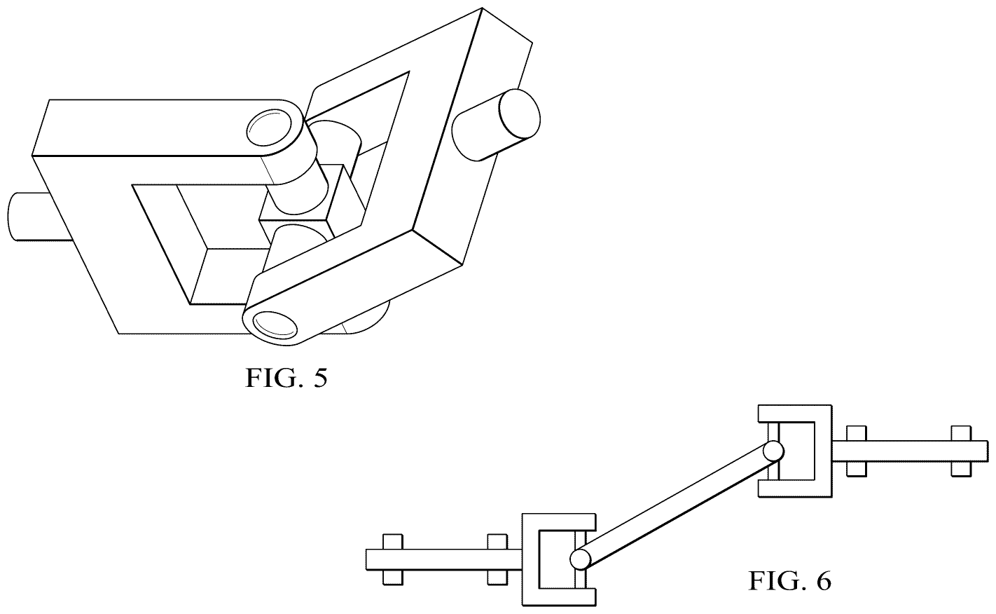

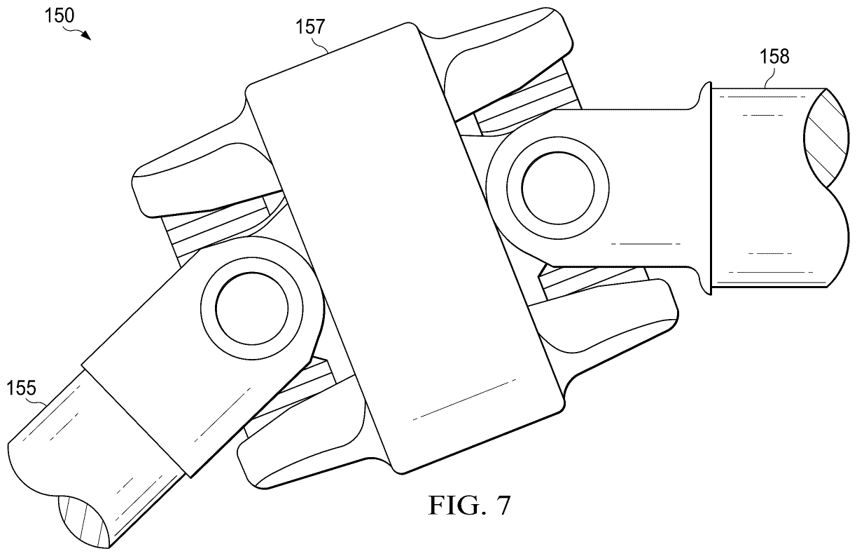

One of ordinary skill in the art would already be familiar with numerous existing devices that utilize flexible drivetrains such as that contemplated in the present invention. For example, in the oil and gas industry, pumps used in hydraulic fracturing often utilize a drivetrain similar to that described above. More broadly, most passenger vehicles include a transmission that operates in a similar manner. Accordingly, one of skill in the art would understand that the flexible drivetrain of the present invention could take a number of different forms, including a basic universal joint such as the one illustrated in FIG. 5, a constant-velocity joint such as the one illustrated in FIG. 6, or a double Cardan joint such as the one illustrated in FIG. 7, just to name a few specific examples. Nevertheless, such a connection has not previously been proposed as a solution to the problems associated with alignment of engines and alternators for mobile generators.

The configuration shown in FIG. 1 also allows for novel mounting configurations for the components of the mobile generator. As noted above, the need to maintain alignment between the engine and alternator generally dictates that these components are rigidly connected, either through a direct physical combination or by including them on a single mounting platform. Because the present invention involves de-coupling and separately mounting the engine and alternator, different mounting configurations may be used. For example, as shown in FIG. 1, engine 110 may be mounted on a plurality of isolated rubber mounting elements 160, which may be spaced along the length of the engine.

The use of a flexible drivetrain also allows for flexibility with respect to the relative orientations of the components. One of ordinary skill in the art would understand that a flexible drivetrain allows considerably more freedom in terms of drivetrain length necessary for given components as compared to a conventional drivetrain. This allows the distance between the components connected by a flexible drivetrain to be customized.

This freedom may be advantageous because, for example, it allows the mobile generator to be designed such that heavier components are oriented with their centers of mass arranged closer to the axles of the vehicle 105. Such an arrangement may reduce the required stiffness and consequently the weight of the vehicle 105. One of ordinary skill in the art would also recognize that such improved weight balance may also improve the drivability, safety, and durability of vehicle 105.

In one embodiment, the engine 110 may be mounted to the substantially planar mounting surface 108 at a position that is substantially above one of the axles of the vehicle 105. In another embodiment, the alternator 120 may be mounted to the substantially planar mounting surface 108 at a position that is substantially above one of the axles of the vehicle 105. It is understood that variations may be made in the foregoing without departing from the scope of the present disclosure. In several exemplary embodiments, the elements and teachings of the various illustrative exemplary embodiments may be combined in whole or in part in some or all of the illustrative exemplary embodiments. In addition, one or more of the elements and teachings of the various illustrative exemplary embodiments may be omitted, at least in part, and/or combined, at least in part, with one or more of the other elements and teachings of the various illustrative embodiments.

Any spatial references, such as, for example, “upper,” “lower,” “above,” “below,” “between,” “bottom,” “vertical,” “horizontal,” “angular,” “upwards,” “downwards,” “side-to-side,” “left-to-right,” “right-to-left,” “top-to-bottom,” “bottom-to-top,” “top,” “bottom,” “bottom-up,” “top-down,” etc., are for the purpose of illustration only and do not limit the specific orientation or location of the structure described above.

In several exemplary embodiments, while different steps, processes, and procedures are described as appearing as distinct acts, one or more of the steps, one or more of the processes, and/or one or more of the procedures may also be performed in different orders, simultaneously and/or sequentially. In several exemplary embodiments, the steps, processes, and/or procedures may be merged into one or more steps, processes and/or procedures.

In several exemplary embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although several exemplary embodiments have been described in detail above, the embodiments described are exemplary only and are not limiting, and those skilled in the art will readily appreciate that many other modifications, changes and/or substitutions are possible in the exemplary embodiments without materially departing from the novel teachings and advantages of the present disclosure. Accordingly, all such modifications, changes, and/or substitutions are intended to be included within the scope of this disclosure as defined in the following claims. In the claims, any means-plus-function clauses are intended to cover the structures described herein as performing the recited function and not only structural equivalents, but also equivalent structures. Moreover, it is the express intention of the applicant not to invoke 35 U.S.C. § 112, paragraph 6 for any limitations of any of the claims herein, except for those in which the claim expressly uses the word “means” together with an associated function.

1. A mobile generator comprising:
a vehicle comprising a substantially planar mounting surface;
an engine mounted on the mounting surface;
an alternator mounted on the mounting surface separate from the engine; and
a flexible drivetrain configured to transmit torque from the engine to the alternator.

2. The mobile generator of claim 1, wherein the flexible drivetrain comprises a universal joint.

3. The mobile generator of claim 1, wherein the flexible drivetrain comprises a constant-velocity joint.

4. The mobile generator of claim 1, wherein the flexible drivetrain comprises a double Cardan joint.

5. The mobile generator of claim 1, further comprising a gearbox disposed between the engine and the alternator, such that torque is transmitted from the engine to the gearbox and from the gearbox to the alternator.

6. The mobile generator of claim 5, wherein the gearbox is mounted on the mounting surface separate from the engine and alternator, and wherein the engine is connected to the gearbox by a rigid coupling.

7. The mobile generator of claim 5, wherein the gearbox is mounted on the mounting surface separate from the engine and alternator, and wherein the gearbox is connected to the alternator by a rigid coupling.

8. The mobile generator of claim 5, wherein the gearbox is mounted to the engine.

9. The mobile generator of claim 5, wherein the gearbox is mounted to the alternator.

10. The mobile generator of claim 1, further comprising a plurality of rubber mounting elements disposed between the engine and the mounting surface.

11. The mobile generator of claim 1, wherein the rated power of the engine is greater than 2.5 megawatts.

12. The mobile generator of claim 5, wherein the generator is configured to output electricity at a frequency of 60 hertz.

13. The mobile generator of claim 12, wherein the engine is configured to operate at 1500 RPM.

14. The mobile generator of claim 1, wherein the vehicle further comprises one or more axles and the engine is mounted on a portion of the surface substantially above one of said axles.

15. The mobile generator of claim 1, wherein the vehicle further comprises one or more axles and the alternator is mounted on a portion of the surface substantially above one of said axles.
